(19) United States
(12) Patent Application Publication
(10) Pub. No.: US 2012/0053830 A1
(43) Pub. Date: Mar. 1, 2012

(54) METHOD OF OPERATING A NAVIGATION SYSTEM TO PROVIDE A TRANSIT ACCESS MAP

(76) Inventor: Jeffrey R. Bach, Aurora, IL (US)

(21) Appl. No.: 12/872,230

(22) Filed: Aug. 31, 2010

(51) Int. Cl. G01C 21/00; G01C 21/36

(52) U.S. Cl. 701/438

(57) ABSTRACT

Disclosed herein is a method that includes (a) receiving a query for one or more areas accessible from a starting location (e.g., a current location) by public transit under one or more trip conditions, (b) identifying one or more areas accessible from the starting location by public transit under one or more trip conditions, and (c) displaying a map that highlights the accessible one or more areas (e.g., a map that depicts only the accessible one or more areas or a map that shades the one or more areas). The one or more trip conditions may include time of day, maximum length of time, maximum travel cost, preferred and/or permitted public transit types, maximum walking distance, maximum number of transfers, etc.

### BACKGROUND

Computing platforms (also known as computing devices or computing systems) are available that provide users with various navigation-related functions and features. Such computing platforms may be referred to as “navigation systems,” and may include mobile phones, smart phones, personal navigation devices (PNDs), vehicle navigation systems, personal digital assistants (PDAs), tablets, etc., and general computing devices, such as personal computers, on which a navigation-related software application is installed.

Some navigation systems are able to determine an optimum route to travel along a road and/or a pedestrian pathway from an origin location to a destination location in a region. Using input from a user, and optionally from equipment that can determine the user's location (such as a GPS system), the navigation system can examine various potential routes between the origin and destination locations to determine the optimum route. The navigation system may then provide the user with information about the optimum route in the form of guidance that identifies the driving and/or walking maneuvers required to be taken by the user to travel from the origin to the destination location. The guidance may take the form of visual and/or audio instructions that are provided along the way as the user is traveling the route. Some navigation systems are able to show detailed maps on displays outlining the route, the types of maneuvers to be taken at various locations along the route, locations of certain types of features, and so on.

In order to provide these and other navigation-related functions and features, navigation systems use map data. The map data may be in the form of one or more geographic databases that include data representing physical features in the region. The geographic database may include information about the represented features. For example, the map data may include information about a road network, such as the positions of roads, speed limits along portions of roads, address ranges along the road portions, turn restrictions at intersections of roads, direction restrictions, such as one-way streets, and so on. As another example, the map data may include information about points of interest, such as restaurants, coffee shops, hotels, airports, gas stations, stadiums, police stations, museums, tourist attractions and so on. Other examples are possible as well.

While navigation systems provide useful information to users, there continues to be room for new features and improvements.

### SUMMARY OF THE INVENTION

To address these and other objectives, the present invention comprises a method for operating a navigation system. The method receives a query for one or more areas accessible from a starting location by public transit under one or more trip conditions. The method identifies a first transit stop in proximity to the starting location and identifies at least one travel route along a public transit line that connects to the identified transit stop. The method further identifies at least one second transit stop on the identified travel route that can be accessible under one or more trip conditions and identifies regions around the second transit stop that can be accessible from the second transit stop under the one or more trip conditions. The method generates a map that highlights the identified regions around the second transit stop that can be accessible from the second transit stop under the one or more trip conditions.

### BRIEF DESCRIPTION OF THE DRAWINGS

FIG. 1 is a block diagram of a navigation system associated with a computing platform, according to an example embodiment.

FIG. 2 illustrates a map of a portion of a geographic region, according to an example embodiment.

FIG. 3 is a block diagram of a geographic database that represents the geographic region included in the navigation system depicted in FIG. 1, according to an example embodiment.

FIG. 4 is a block diagram of a road segment data record and a node data record contained in the geographic database depicted in FIG. 3, according to an example embodiment.

FIG. 5 is a block diagram of a transit line data record and a transit stop record contained in the geographic database depicted in FIG. 3, according to an example embodiment.

FIG. 6 is a flow chart depicting a method of identifying and displaying one or more accessible areas, according to an example embodiment.

FIG. 7 illustrates a map of a geographic region that depicts areas that are accessible from a starting location by public transit under the one or more trip conditions, according to an example embodiment.

### DETAILED DESCRIPTION

The example embodiments described herein may enable a navigation system to identify and then provide a user with a map that highlights areas and/or locations that are accessible from a starting location (e.g., the user's current location) by public transit together with travel on the road and pedestrian network under certain conditions. In this respect, the user can then easily visualize those accessible areas and/or locations and thereby decide whether to further investigate a trip to the accessible areas via public transit.

As used herein, the term “public transit” may encompass any shared passenger transportation modes available for use by the general public, including but not limited to railroads (long distance train lines), public bus lines (city public transit bus lines), tourist bus lines (bus systems that serve tourist areas and provide transport between tourist attractions), metro railway lines (rapid transit lines such as subways and elevated lines that provide rail-based public transit within a city or metro area), light rail (light rail vehicles with tracks running along a street, such as trams, trolleys, or street cars), water taxi (a boat providing transit service within an urban area.), monorail (rail transit system operating on a single beam that may be elevated).

It should be understood that the arrangements described herein are set forth for purposes of example only. As such, those skilled in the art will appreciate that other arrangements and other elements (e.g., components, interfaces, functions, orders of functions, etc.) can be used instead, some elements may be added, and/or some elements may be omitted altogether. Further, those skilled in the art will appreciate that many of the elements described herein are functional elements that may be implemented as discrete or distributed components or in conjunction with other components, and in any suitable combination and location. Still further, various functions described herein as being performed by one or more entities may be carried out by hardware, firmware and/or software. For instance, various functions may be carried out by a processor executing a set of program instructions written in any suitable programming language (e.g., C, C++, Java, etc.) and stored in memory.

### I. Navigation System

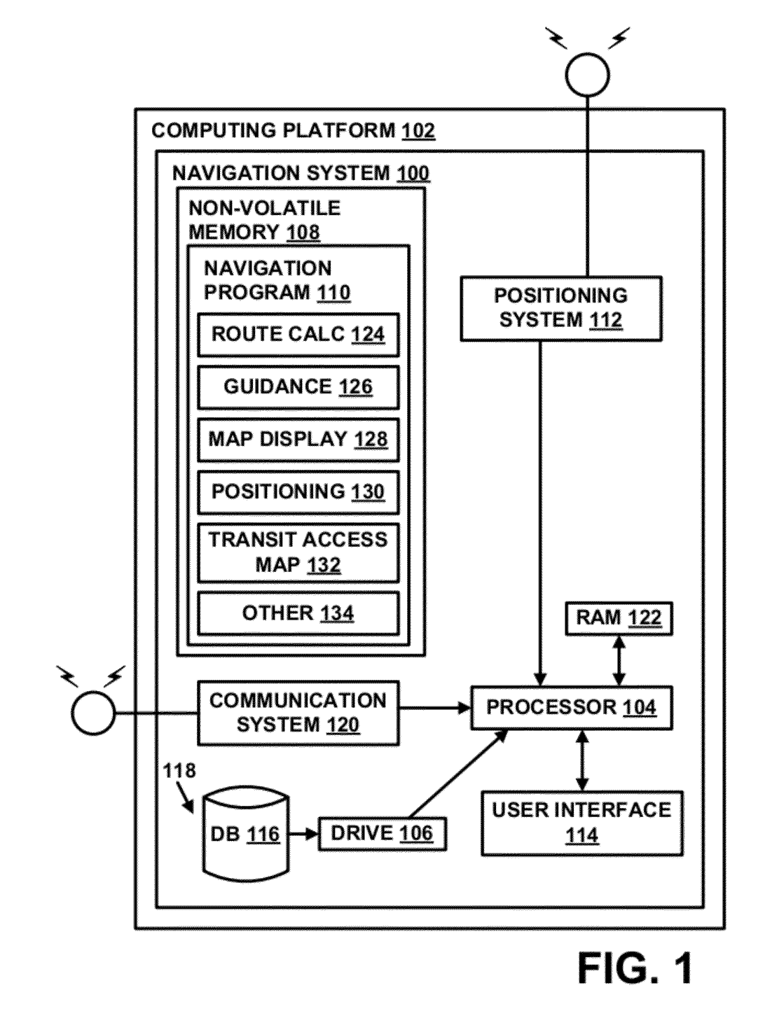

FIG. 1 is a block diagram of a navigation system 100 associated with a computing platform 102, such as a mobile phone, smart phone, personal navigation device (PND), vehicle navigation system, personal digital assistant (PDA), tablet, personal computer, or any other computer, according to an example embodiment. The navigation system 100 is a combination of hardware and software components. In one embodiment, the navigation system 100 includes a processor 104 (e.g., one or more general purposes processors, application-specific processors, and/or programmable logic devices), a drive 106 connected to the processor 104, and a non-volatile memory storage device 108 (e.g., read only memory (ROM), a hard disk drive, a solid state drive, etc.) for storing navigation application software programs 110 and possibly other information.

The navigation system 100 may also include a positioning system 112. The positioning system 112 may utilize GPS-type technology, a dead reckoning-type system, or combinations of these or other systems, all of which are known in the art. The positioning system 112 may include suitable sensing devices that measure the traveling distance speed, direction, orientation and so on. The positioning system 112 may also include a GPS system. The positioning system 112 outputs a signal to the processor 104, and the navigation application software programs 110 that run on the processor 104 may use the signal from the positioning system 112 to determine the location, direction, orientation, etc., of the computing platform 102.

The navigation system 100 may also include a user interface 114 that allows a user to input information into the navigation system 100 and obtain information from the navigation system 100. The user interface 114 includes a display to illustrate a map image. The input information may include a request for navigation features and functions of the navigation system 100. To provide navigation features and functions, the navigation system 100 may use a geographic database 116 stored on computer-readable storage medium 118. (It should be understood that the geographic database 116 may also be stored in whole or in part on the non-volatile memory storage device 108 or some other storage device or medium). In one embodiment, the storage medium 118 is installed in the drive 106 so that the geographic database 116 can be read and used by the navigation system 100. In one embodiment, the geographic database 116 may be a geographic database published by NAVTEQ North America, LLC of Chicago, Ill. The storage medium 118 and the geographic database 116 do not have to be physically provided at the location of the navigation system 100. In alternative embodiments, the storage medium 118—upon which the geographic database 116 may be stored in whole or in part—may be located remotely from the rest of the navigation system 100, in which case portions of the map data may be provided via a communications system 120, as needed.

In one example type of system, the navigation application software programs 110 may load from the non-volatile memory storage device 108 into a random access memory (RAM) 122 associated with the processor 104. The processor 104 may also receive input from the user interface 114. The navigation system 100 may use the geographic database 116 stored on the storage medium 118, possibly in conjunction with the outputs from the positioning system 112 and the communications system 120, to provide various navigation features and functions. The navigation application software programs 110 may include separate applications (or subprograms) that provide the various navigation-related features and functions. For example, the navigation functions and features may include route calculation 124 (wherein a route from an origin to a destination is determined), route guidance 126 (wherein detailed directions are provided for reaching a desired destination), map display 128 (wherein a map depicting locations and routes are shown on a display), positioning 130 (e.g., map matching) and transit access map 132 that will be described in detail below.

Other functions and programming 134 may also be included in the navigation system 100, including people and business finding services (e.g., electronic yellow and white pages), point of interest searching, destination selection, and location base advertising services.

In alternative embodiments, the navigation system 100 may include local components, located physically with a user, that communicate with remote components, located remotely from the user. In this embodiment, the remote components may include a navigation services server. The navigation application software programs 110 and the geographic database 116 may reside with the navigation server. The local components of the navigation system may communicate with the remote components via a communication link. The communication link may use any suitable technology and/or protocols that are currently available, as well as technology and/or protocols that become available in the future. A portion of the communications link may include a wireless portion that enables two-way communication between the local components and the remote components. The wireless portion may be implemented by any suitable form of wireless communication, including cellular, PCS, satellite, FM, radio, Bluetooth®, other long and short range transmission technologies or technologies that may be developed in the future.

### II. Geographic Database

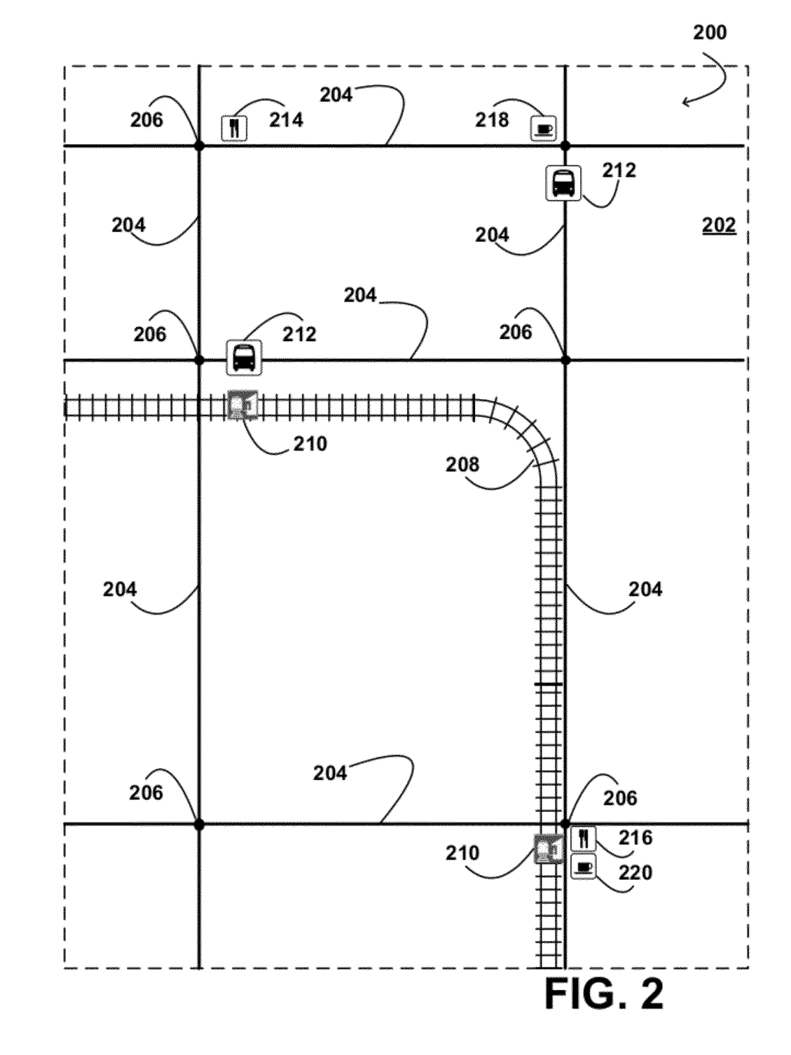

In order to provide navigation-related features and functions to the user, the navigation system 100 uses the geographic database 116. The geographic database 116 includes information about one or more geographic regions. FIG. 2 illustrates a map 200 of a portion of a geographic region 202, according to an example embodiment. The geographic region 202 may correspond to a metropolitan or rural area, a state, a country, or combinations thereof, or any other area. Located in the geographic region 202 are physical geographic features, such as roads, railways (e.g., rapid transit railways, commuter rail lines, etc.), points of interest (e.g., businesses, facilities, etc.), pedestrian pathways (e.g., sidewalks, paths, etc.), bodies of water (e.g., oceans, lakes, rivers, etc.), etc.

As shown, the map 200 illustrates features in the geographic region 202 that are associated with a road network. For example, the geographic region 202 is shown as including one or more road segments 204 that each represents a portion of a road; some of the road segments 204 have associated sidewalks. The geographic region 202 may further include pedestrian paths not associated with road segments, such as pedestrian only zones and pathways. The sidewalks and pedestrian paths make up a pedestrian network for travel by pedestrians. Each road segment 204 is shown to have associated with it two nodes 206; one node represents the point at one end of the road segment and the other node represents the point at the other end of the road segment. The node 206 at either end of a road segment 204 may correspond to a location at which the road meets another road, i.e., an intersection, or where the road dead-ends. Other examples are possible as well.

The map 200 further illustrates features in the geographic region 202 that are associated with a public transit system. For example, the geographic region 202 is shown as including a railway 208 and a plurality of railway stops 210 associated with one or more railway lines. (As used herein, the terms “stop” and “station” may be used interchangeably). As another example, the geographic region 202 is shown as including a plurality of bus stops 212 associated with one or more bus lines. (It should be understood that road segments and nodes may also be associated with the one or more bus lines). Other examples are possible as well.

The map 200 still further illustrates points of interest in the geographic region 202. For example, the geographic region 202 is shown as including restaurants 214 and 216 and coffee shops 218 and 220. Many other examples are possible as well.

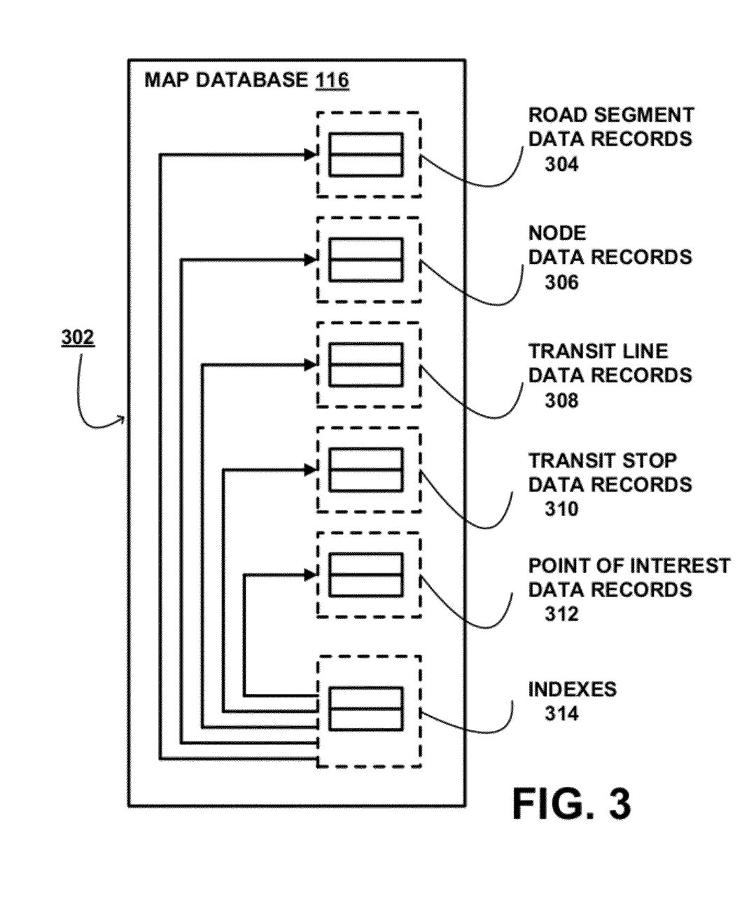

Referring to FIG. 3, the geographic database 116 contains data 302 that represents some of the features in the geographic region 202 depicted in FIG. 2. In one embodiment, the data 302 contained in the geographic database 116 may includes data that represents features associated with the road network in the geographic region 202. For example, the geographic database 116 that represents the geographic region 202 may contain at least one road segment data record 304 (or “entity” or “entry”) for each road segment 204 in the geographic region 202. As another example, the geographic database 116 that represents the geographic region 202 may include a node data record 306 (or “entity” or “entry”) for each node 206 in the geographic region 202. Other examples are possible as well. It should be understood that the terms “segments” and “nodes” represent only one terminology for describing these physical geographic features, and other terminology for describing these features is intended to be encompassed within the scope of these concepts.

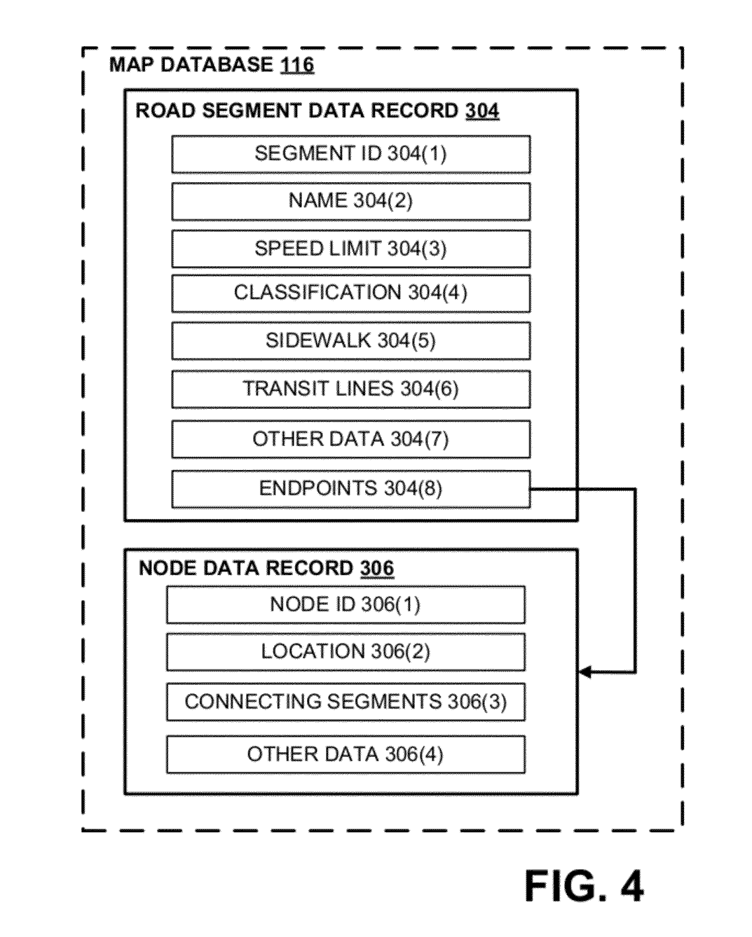

FIG. 4 shows components of a road segment data record 304 contained in the geographic database 116, according to an example embodiment. As shown, in one aspect, the road segment data record 304 may include or be associated with a segment ID 304(1) by which the data record can be identified in the geographic database 116.

In another aspect, the road segment data record 304 may include or be associated with data that indicates attributes of the represented road segment. For example, the road segment data record 304 may include or be associated with data 304(2) that indicates the name of the road to which the road segment belongs. In another example, the road segment data record 304 may include or be associated with data 304(3) that indicates a speed limit on the represented road segment. In yet another example, the road segment data record 304 may include or be associated with data 304(4) indicating a classification of the road to which the represented road segment belongs (e.g., controlled access road, ramp, bridge, tunnel, toll road, etc.). In still another example, the road segment data record 304 may include or be associated with data 304(5) indicating a sidewalk associated with the represented road segment. In a further example, the road segment data record 304 may include or be associated with data 304(6) about any public transit lines (e.g., bus lines) associated with the road segment, such as an identifier, name, and/or type of the transit line(s). The road segment data record 304 may also include or be associated with other data 304(7) that indicates other attributes of the represented road segment (e.g., restrictions on the direction of vehicular travel, street address ranges, length and shape of the road segment and so on.).

In yet another aspect, the road segment data record 304 may include or be associated with data 304(8) identifying endpoint nodes of the represented road segment. For example, the data 304(8) may include an identifier and/or a geographic location (e.g., latitude and longitude) of each endpoint node. As another example, the data 304(8) may include a link to a node data record 306 for each endpoint node. As yet another example, the data 304(8) may identify one endpoint as a starting node. Other examples are possible as well.

FIG. 4 further shows components of a node data record 306 contained in the geographic database 116, according to an example embodiment. As shown, in one aspect, the node data record 306 may include or be associated with a node ID 306(1) by which the node can be identified in the geographic database 116. In another aspect, the node data record 306 may include or be associated with data indicating various attributes of the represented node. For example, the node data record 306 may include or be associated with data 306(2) indicating a geographic location (e.g., latitude and longitude) of the represented node. In another example, the node data record 306 may include or be associated with data 306(3) identifying each road segment connected to the represented node. The node data record 306 may also include or be associated with other data 306(4) that indicates other attributes of the represented node.

Referring back to FIG. 3, in another embodiment, the data 302 contained in the geographic database 116 may include data that represents a public transit system in the geographic region 202. For example, the geographic database 116 that represents the geographic region 202 may contain at least one transit line data record 308 (or “entity” or “entry”) for each transit line in the geographic region 202 (e.g., a railway line running on the railway 208, a bus line running on the road segments 204 and nodes 206, etc.). As another example, the geographic database 116 that represents the geographic region 202 may include a stop data record 310 (or “entity” or “entry”) for each transit stop in the geographic region 202 (e.g., railway stops 210, bus stops 212, etc.). As above, it should be understood that the terms “lines” and “stops” represent only one terminology for describing these physical geographic features, and other terminology for describing these features is intended to be encompassed within the scope of these concepts.

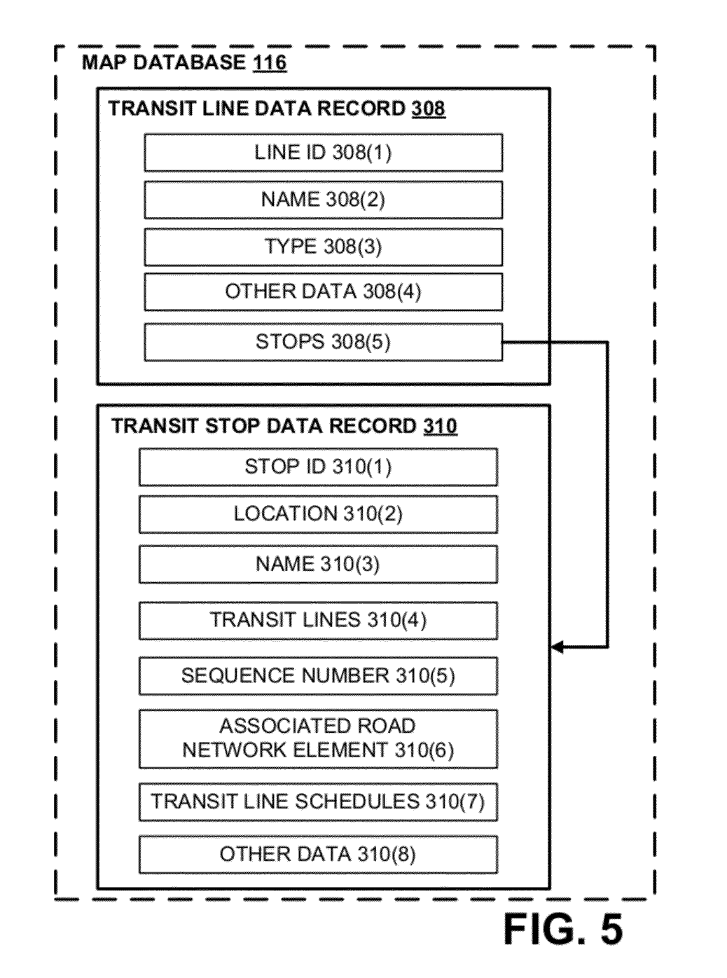

FIG. 5 shows components of a transit line data record 308 contained in the geographic database 116, according to an example embodiment. As shown, in one aspect, the transit line data record 308 may include or be associated with a line ID 308(1) by which the transit line can be identified in the geographic database 116

In another aspect, the transit line data record 308 may include or be associated with data indicating various attributes of the represented transit line. For example, the transit line data record 308 may include or be associated with data 308(2) indicating a name of the represented transit line. As another example, the transit line data record 308 may include or be associated with data 308(3) indicating a type of the represented transit line (e.g., bus line, rapid transit line, commuter rail line, etc.). The transit line data record 308 may also include or be associated with other data 308(4) indicating other attributes of the represented transit line (e.g., cost).

In yet another aspect, the transit line data record 308 may include or be associated with data 308(5) identifying stops associated with the represented transit line. For example, the data 308(5) may include an identifier and/or a geographic location (e.g., latitude and longitude) of each stop associated with the represented transit line. As another example, the data 308(5) may include a reference to a stop data record 310 for each stop associated with the represented transit line. Other examples are possible as well. (Although not shown, the transit line data record may similarly include or be associated with data identifying railways and/or road network elements associated with the represented transit line).

FIG. 5 further shows components of a stop data record 310 contained in the geographic database 116, according to an example embodiment. As shown, in one aspect, the stop data record 310 may include or be associated with a stop ID 310(1) by which the represented stop can be identified in the geographic database 116. In another aspect, the stop data record 310 may include or be associated with data indicating various attributes of the represented stop. For example, the stop data record 310 may include or be associated with data 310(2) indicating a geographic location (e.g., latitude and longitude) of the represented stop. In another example, the stop data record 310 may include or be associated with data 310(3) indicating a name of the represented stop. In yet another example, the stop data record 310 may include or be associated with data 310(4) identifying public transit line(s) associated with the represented stop. In still another example, the stop data record 310 may include or be associated with data 310(5) indicating a sequence number of the represented stop within each associated public transit line (e.g., stop #4).

In a further example, the stop data record 310 may include or be associated with data 310(6) indicating an association between the represented stop and a road network or pedestrian network element. For example, the data 310(6) may provide a road segment ID or node ID corresponding to the location of the stop. The data 310(6) indicating an association between the stop and the road network or pedestrian network provides a connection between the transit line and the road/pedestrian network, such as from the bus stop to a sidewalk associated with a road segment that the bus stop is located on. The data 310(6) may also indicate an access level of the represented stop with respect to the associated road network element (e.g., above, below, or at street level). In yet a further example, the stop data record 310 may include or be associated with data 310(7) indicating transit line schedule(s) for the represented stop (e.g., departure and arrival times for associated transit line runs). The stop data record 310 may also include or be associated with other data 310(8) indicating other attributes of the represented stop.

Referring back to FIG. 3, in yet another embodiment, the geographic database 116 may include data that represents points of interest in the geographic region 202, such as restaurants 214 and 216 and coffee shops 218 and 220. For example, the geographic database 116 that represents the geographic region 202 may contain one or more point of interest data records 312 that each includes, among other things, an identifier of a represented point of interest and data indicating attributes of the represented point of interest (e.g., location, type, phone number, hours of operation, etc.). Other examples are possible as well.

The geographic database 116 may additionally include indexes 314. The indexes 314 may include various types of indexes that associate different types of data contained in the geographic database 116 to each other or that associate to other aspects of the data contained in the geographic database 116. For example, the indexes 314 may associate road segment data records 304 with road node data records 306. As another example, the indexes 314 may associate transit line data records 308 with stop data records 310. As yet another example, the indexes 314 may associate transit line data records 308 and/or stop data records 310 with road data records 304, node data records 306, and/or data records representing railways (not shown). As still another example, the indexes 314 may associate point of interest data records 312 with road segment data records 304, node data records 306, transit line data records 308, stop data records 310, and/or data records representing railways (not shown). Other examples are possible as well.

The data 302 may be organized in the geographic database 116 in various manners. In one example, the data 302 may be organized according to type, such that road segment data records 304, road node data records 306, transit line data records 308, and stop data records 310 are each maintained separately. In another example, the data 302 may be organized according to network, such that data records for the road network are maintained separately from data records for the public transit network. In still another example, the data 302 may be organized according to location, such that data records associated with a first region are maintained separately from data records associated with other regions. In a further example, the data 302 may be organized according to navigation-related functions, such that data records associated with a given navigation-related function (e.g., routing) are maintained separately from data records associated with other navigation-related functions (e.g., map display). Many other examples are possible as well.

### III. Transit Access Map

As discussed above in conjunction with FIG. 1, the navigation system 100 includes navigation application software programs 110 that provide the various navigation features and functions. In one embodiment, the navigation functions and features may include a transit access map function 132. The transit access map function 132 identifies various areas and/or locations that are accessible from a starting location (e.g., the person's current location) by public transit together with travel on the road and pedestrian network under certain conditions (e.g., time, cost, etc.). For example, a person that has a several hour layover at an airport of an unfamiliar city may wish to identify areas and/or locations that may be visited from the airport by a combination of public transit and walking during the layover time period. In this respect, it would be beneficial to display these accessible areas and/or locations on a map in a manner that enables the person to easily visualize the accessible areas and/or locations, and thereby decide whether to further investigate a trip to those areas and/or locations and whether to travel to those areas and/or locations.

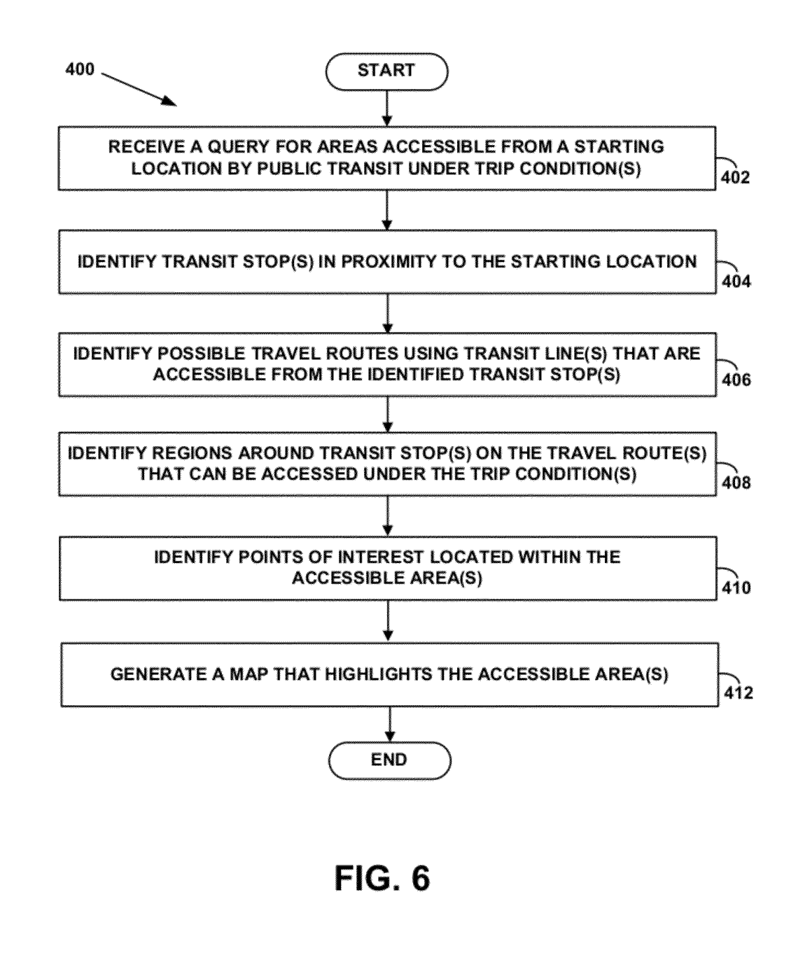

FIG. 6 depicts a flow chart illustrating a method 400 of identifying and generating a transit access map, according to an example embodiment. For purposes of illustration, the following description will assume that the navigation system 100 executes the transit access map function 132 which is one of the navigation application software programs 110 (or subprograms) stored in the non-volatile memory storage device 108. It should be understood, however, that other systems, platforms, or devices may carry out one or more steps of the method 400 without departing from the scope of the example embodiment.

At step 402, the transit access map function 132 receives a query for a transit access map that shows the areas accessible from a starting location by public transit under one or more trip conditions. For example, the transit access map function 132 may receive a query from a user via the user interface 114. In this respect, the query may take various forms, including text input, speech input, and/or selection of an icon or link for instance. Other examples are possible as well.

The starting location may take various forms. In one example, the starting location is a current location of the navigation system 100. In another example, the starting location may be some location other than the current location of the navigation system 100, such as a user's future location or a specified location; other examples are possible as well. The transit access map function 132 may obtain the starting location in various manners. In one example, the transit access map function 132 obtains the current location via the positioning system 112 and/or positioning function 130 in response to receiving the query. In another example, a user may input the starting location when initiating a query via the user interface 114, in which case the transit access map function 132 may receive the starting location with the query. In still another example, a user may store a starting location on the navigation system 100 before initiating a query, in which case the transit access map function 132 may obtain the starting location from storage in response to receiving the query. Other examples are possible as well.

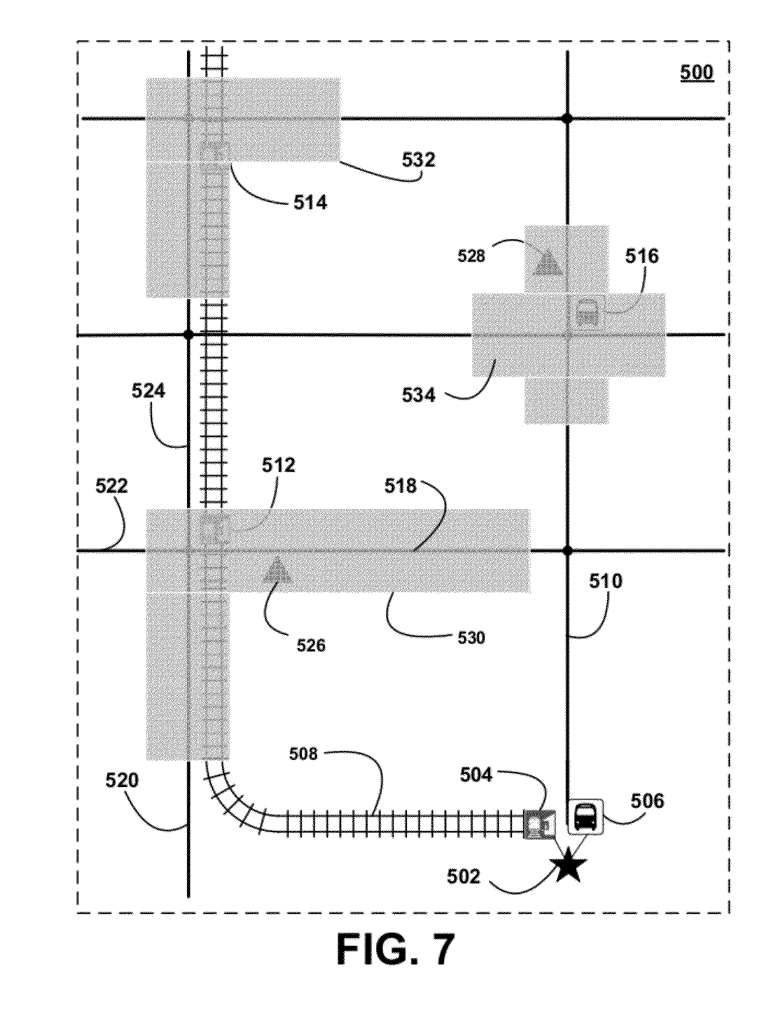

FIG. 7 illustrates a map 500 of a portion of a geographic region; for convenience, FIG. 7 will be used to illustrate one example of the method for identifying and generating the transit access map. A starting location 502 is shown in FIG. 7. For the example, the starting location is located within an airport corresponding to the current location of the user.

The one or more trip conditions may take various forms. In one example, the one or more trip conditions may include time conditions for the trip, such as a time of day and/or a maximum length of time (e.g., for the entire trip, one leg of the trip, etc.). In another example, the one or more trip conditions may include a maximum cost for the trip. In yet another example, the one or more trip conditions may include preferred and/or permitted types of public transit for the trip. In still another example, the one or more trip conditions may include a maximum number of transfers between public transit lines for the trip (e.g., for the entire trip, one leg of the trip, etc.). In a further example, the one or more trip conditions may include a maximum walking distance for the trip (e.g., for the entire trip, one leg of the trip, etc.). In another example, the trip condition may include a walking trip that avoids stairs and uphill walking, a wheel chair accessible trip, and/or a walking trip through safe, low crime areas. In yet a further example, the one or more trip conditions may include an indication of whether a return trip from the one or more areas is desired. In still a further example, the one or more trip conditions may include an indication of whether a taxicab can be considered for certain portions of the trip. Other examples are possible as well.

For the example that will be illustrated with FIG. 7, the user requesting the transit access map has a four hour layover before his or her flight. For this example, one of the trip conditions is returning to the airport to make the user's flight. Considering that the user must return to the airport at least one hour prior to the flight, one of the trip conditions is a maximum round trip time of three hours. An additional trip condition for this example is walking as the desired mode of transportation other than public transit.

The transit access map function 132 may obtain the one or more trip conditions in various manners. In one example, the user may input one or more trip conditions when initiating a query via the user interface 114 of the navigation system 100, in which case the transit access map function 132 may receive the one or more trip conditions with the query. In another example, the user may store one or more trip conditions on the navigation system 100 before initiating a query, in which case the transit access map function 132 may obtain the one or more trip conditions from storage in response to receiving the query. In still another example, one or more trip conditions may be independent of user input (e.g., current time of day), in which case the transit access map function 132 may determine the one or more trip conditions (e.g., via the processor 104, positioning system 112, and/or communication system 120) in response to receiving the query. In a further example, the transit access map function 132 may use default trip conditions, such as a travel distance of two miles from a transit stop. In yet another example, the transit access map function 132 accesses another application operating on the computing platform 102 or operating remote from the computing platform 102 to obtain the one or more trip conditions. For example, the transit access map function 132 may access a calendar application or trip itinerary to determine when the user has a flight and to set the trip conditions including a time that the user must be back at the airport. Other examples are possible as well.

In one embodiment, the query for the transit access map may additionally include a query for points of interest in the one or more accessible areas. In this respect, the query may include search criteria for points of interest located within the one or more accessible areas. For example, the query may include search criteria for a type of point of interest (e.g., a coffee shop, restaurant, museum, tourist attraction) or a name of a point of interest (“Jeff's BBQ Restaurant”) within the one or more areas. Other examples are possible as well.

At step 404, after receiving the query, the transit access map function 132 identifies one or more transit stops in proximity to the starting location that are accessible from the starting location. In one aspect, the transit access map function 132 obtains transit stop data records 310 from the geographic database 116 to identify one or more transit stops in proximity to the starting location, such as a short walk of a quarter of a mile from the starting location. For example, the transit access map function 132 obtains geographic location data 310(2) in the transit stop data record 310 and compare this location data to the starting location to determine whether the transit stop is within a given distance of the starting location (e.g., a maximum walking distance specified in the one or more trip conditions). As another example, the transit access map function 132 may obtain geographic location data 310(2) in the transit stop data records 310 to identify transit stops having a geographic location that can be reached by foot and/or taxicab within a given timeframe (e.g., a percentage of the maximum length of time specified in the trip conditions). Other examples are possible as well. The transit access map function 132 may identify the transit stop(s) in proximity to the starting location in other manners as well. Referring to FIG. 7, a train stop 504 and a bus stop 506 are proximate the starting location 502. The user at the starting location 502 of the airport may walk from the airport terminal to both the train stop 504 and the bus stop 506 that connect to the airport.

At step 406, after identifying the transit stop(s) in proximity to the starting location, the transit access map function 132 identifies one or more possible travel routes using transit line(s) that pass through the identified transit stop(s) in proximity to the starting location. The travel route may comprise a series of transit stops along the transit line. Additionally, the travel route may comprise a transfer at one of the transit stops to another transit line. In one aspect, the transit access map function 132 obtains transit line data 310(4) from the transit stop data records 310 for the transit stop(s) identified in step 404 to identify the transit line(s) that pass through these transit stop(s). In another aspect, the transit access map function 132 may use the index data 314 for the one or more indexes associating the transit stop data records 310 for the identified stop(s) with transit line data records 308. The transit access map function 132 may identify the transit line(s) that are accessible from the identified transit stop(s) in other manners as well. Referring to FIG. 7, a train line 508 begins at train stop 504, and a bus line 510 begins at the bus stop 506.

The transit access map function 132 determines an extent of each of the identified travel routes along the identified transit line(s) based on the trip conditions. When determining the extent of the travel routes or travel distance along the transit lines, the transit access map function 132 obtains data from the geographic database 116 to consider the one or more trip conditions. In one aspect, the transit access map function 132 obtains transit line schedules data 310(7) to identify which transit stops on the transit line may be reached within an allotted time of the trip condition. In another aspect, the transit access map function 132 may obtain real time data representing any delays on the transit line, representing the expected time of arrival at transit stops and so on. In another example, if the one or more trip conditions include a maximum number of transfers between transit lines, the transit access map function 132 may identify only transit line(s) that can be accessed within the specified maximum number of transfers. As yet another example, if the one or more trip conditions include a maximum cost for the trip, the transit access map function 132 may identify only transit line(s) that can be accessed at a cost that is less than or equal to the specified maximum cost. For example, if the one or more trip conditions include preferred and/or permitted types of public transit, the transit access map function 132 may prioritize the accessible transit line(s) based on type and/or identify only transit line(s) of the permitted types. In another embodiment, the preferred type of public transportation for the trip condition may be a specific transit line for which the user has an existing travel pass. Other examples are possible as well.

Referring to FIG. 7, the transit access map function 132 determines a maximum distance of travel along the identified transit lines of 508 and 510 based on the trip conditions of a completed round trip within 3 hours. For example, the transit access map function 132 obtains a current time of 12:35 PM. Based on the current time, the transit access function 132 determines the time at which the user must return to the airport within 3 hours or by 3:35 PM. Next, the transit access map function 132 obtains the schedules data 310(7) for the train stop 504 of the train line 508 to determine that trains depart train stop 504 every 30 minutes on the quarter hour, such as at 12:15 PM, 12:45 PM, 1:15 PM and so on. Additionally, the transit access map function 132 obtains schedules data 310(7) for the train stop 504 of the train line 508 to determine that trains arrive at train stop 504 every 30 minutes on the hour and half hour, such as at 1:00 PM, 1:30 PM, 2:00 PM and so on. Given the current time of 12:35 PM, the earliest train that the user may take from train stop 504 is at 12:45 PM, and the user must return on the 3:30 PM train at train stop 504. Accordingly, the transit access map function 132 uses the 12:45 PM departing train as the start of the travel route from train stop 504 and the 3:30 PM arriving train at train stop 504 as the end of the round trip travel route. These trains will maximize the travel time from the airport, and thus maximize the extent of the areas accessible from the train line 508.

For the example of FIG. 7, the transit access map function 132 obtains schedule data 310(7) for the next train stop 512 on the train line 510 and determines that the 12:45 PM departing train from train stop 504 arrives at train stop 512 at 1:00 PM. Additionally, the transit access map function 132 obtains schedules data 310(7) for the train stop 512 and determines that the 3:30 PM arriving train at train stop 504 departs the train stop 512 at 3:15 PM. Thus, a travel route from the train stop 504 to train stop 512 meets the travel condition of the three hour round trip. Next, the transit access map function 132 determines whether the next train stop 514 on train line 508 may be accessed within the three hour round trip travel condition. The transit access map function 132 obtains schedules data 310(7) for the train stop 514 and determines that the 12:45 PM departing train from train stop 504 arrives at train stop 514 at 1:25 PM. Additionally, the transit access map function 132 obtains schedules data 310(7) for the train stop 514 and determines that the 3:30 PM arriving train at train stop 504 departs the train stop 512 at 2:55 PM. Thus, the transit access map function 132 determines that the travel route from the train stop 504 along train line 508 extending to train stop 514 meets the travel condition of the three hour round trip. This process continues with the transit access map function 132 obtaining and analyzing the schedule data 310(7) of the next train stop on the train line 508 until the next train stop may not be reached and returned from within the trip condition of three hours. Likewise, the transit access map function 132 performs a similar process for the bus stops on the bus line 510 identifying that bus stop 516 may be reached within three hours.

At step 408, after identifying the travel route(s) comprising transit line(s), the transit access map function 132 identifies regions around transit stop(s) on the travel route(s) that can be accessed under the one or more trip conditions. In one embodiment, the transit access map function 132 obtains associated road network element data 310(6) and pedestrian network data from the geographic database 116 to identify one or more areas that can be accessed from the accessible transit stop(s) under the one or more trip conditions. For example, the transit access map function 132 obtains data representing the road network and pedestrian network from the geographic database 116 to identify one or more regions that are within a given distance of the transit stop. For example, the transit access map function 132 determines whether a road segment proximate the stop includes a sidewalk that would allow the user to walk away from the transit stop. The extent of the region may be determined as a maximum walking distance along road segments having sidewalks. As another example, the transit access map function 132 obtains and evaluates data from road segment data records 304 and/or node data records 306 to identify the distance of travel along road segments that can be reached by a taxicab from the transit stop within a given timeframe (e.g., a percentage of the maximum length of time specified in the trip conditions). Other examples are possible as well.

Referring to FIG. 7, the transit access map function 132 identifies regions around each of the transit stops 512, 514 and 516 on the identified travel routes that can be accessed within the 3 hours and walking trip conditions. For example, to determine the distance that the user may walk along the sidewalk of road segment 518, the transit access map function 132 determines the available time of a walking portion from the train stop 512. For example, the user will arrive at stop 512 at 1:00 PM and will depart at 3:15 PM providing a walking time of approximately 2 hours and 15 minutes. In one embodiment, the walking time is reduced by a predetermined amount, such as one half hour, representing the likelihood that the user will visit a point of interest during the walking portion. Using the walking time of 2 hours and 15 minutes and an average walking speed of 2.5 miles per hour, the transit access map function 132 calculates a maximum walking distance of 5.625 miles from the transit stop 512.

To identify possible walking paths from the train stop 512, the transit access map function 132 obtains associated road network element data 310(6) that indicates the train stop 512 connects with road segment 518 allowing the user to exit the train stop 512 and access the road segment 518. Because the travel condition of walking must be satisfied, the transit access map function obtains sidewalk data 304(5) for road segment 518 that indicates a sidewalk adjacent the road segment 518 available for pedestrians. Next, the transit map access function 132 determines the distance from the train stop 512 that may be walked using the road network and pedestrian network that connects to road segment 518. For example, the sidewalk associated with road segment 518 extends from the train stop 512 to the east 6 miles to its east most node, so the transit map access function 132 determines the accessible distance in the east direction from the train stop 512 along road segment 518 is 5.625 miles. The transit map access function 132 obtains data for the road segment 518 indicating the distance between the west most node of the road segment 518 and the train stop 512 is 0.625 miles. Next, the transit map access function 132 obtains connecting segments data 306(3) for the west most node of road segment 518 indicating that road segments 520, 522 and 524 connect to road segment 518. The transit map access function 132 obtains sidewalk data 304(5) for road segments 520, 522 and 524 that indicate a sidewalk adjacent the road segment 520 is available for pedestrians; however, road segments 522 and 524 do not have sidewalks and are inaccessible by walking. Next, the transit map access function 132 determines that a distance of 5 miles may be walked in the south direction along the road segment 520, and a distance of 0 miles may be walked along road segments 522 and 522 because these segments are not accessible to a pedestrian. This process continues with the transit access map function 132 obtaining and analyzing data from the geographic database for the road network and pedestrian network that connect with the train stop 514 and bus stop 516.

Referring to FIG. 6, at step 410, the transit access map function 132 may optionally identify points of interest located within the accessible one or more regions identified in step 408. The transit access map function 132 may perform this identification in various manners. In one aspect, the transit access map function 132 may access point of interest data records 312 in the geographic database 116 to identify those points of interest based on the search criteria received in the query that are located along or proximate to the portion of the road network and/or pedestrian network identified in step 408. Additionally, the transit access map function 132 determines whether the identified points of interest are accessible from the road segments and/or pedestrian segments identified in step 408, such as the points of interest being accessible via an entrance or path that connect the point of interest to the road segment and/or pedestrian segment. Referring to FIG. 7 and the example query for museums, the transit map access function 132 identifies an art museum 526 located along and accessible from the sidewalk of road segment 518. Additionally, the transit map access function 132 identifies an aviation museum 528 located proximate to and accessible from the sidewalks that form a continuous path from the bus stop 516.

At step 412, the transit access map function 132 generates a map image that highlights the accessible one or more areas. Additionally, the portion of the transit lines accessible under the trip conditions may be highlighted. The highlight visually distinguishes the accessible areas from areas that are not accessible under the trip conditions. The map image is displayed on a display of the user interface 114 of the navigation system 100. For this step, the transit access map function 132 uses cartographic data from the geographic database 116 that represent the shapes of the road segments and pedestrian segments as well as other geographic features. In one embodiment, the transit access map function 132 forms polygons around the portions of road segments and/or pedestrian segments identified in step 408. The transit access map function 132 may form polygons that have lengths corresponding to the distance along the road segment and/or pedestrian segment that are accessible under the trip conditions and widths of a fixed perpendicular distance from the road segments and/or pedestrian segments. In one embodiment, the fixed perpendicular distance is chosen to be greater than the distance points of interest are from the road segments and/or pedestrian segments providing polygons that encompass all or a portion of the points of interest located along the road segments and/or pedestrian segments. FIG. 7 illustrates polygons 530, 532 and 534 representing areas accessible under the trip condition. The shapes of the areas 530, 532 and 534 are shown as rectangular; however, other shapes are possible.

The transit access map function 132 may generate the map display using any rendering technique now know or later developed, including any of the techniques disclosed in U.S. Pat. No. 6,092,076. These map display techniques may be embodied in the map display application 128 described above and/or some other navigation application software program 110 (or subprogram) stored in the non-volatile memory storage device 108. The map may highlight the accessible one or more areas to visually distinguish these areas from the areas that are not accessible; the map highlights may take various forms. In one embodiment, the map may highlight the accessible areas by depicting only the accessible areas, while hiding inaccessible areas under the trip conditions. In another embodiment, the map may highlight the accessible areas by shading the accessible areas depicted in the map display, while leaving inaccessible areas unshaded. In yet another embodiment, the geographic features located within the accessible areas may be represented in a visually different manner from geographic features in inaccessible areas, such as accessible features being bolded, shown in a more vivid color and so on. FIG. 7 illustrates a map 500 that shades the accessible areas 530, 532 and 534 and does not shade the non-accessible areas.

In another embodiment, in addition to highlighting the accessible areas, the map may show the identified points of interest located within the accessible areas. FIG. 7 illustrates a map 500 that prominently identifies the points of interest, museums 526 and 528. The map highlights of the accessible areas may take other forms as well.

The transit access map function 132 may optionally display information (e.g., name, address, hours of operation, etc.) about identified points of interest located within the accessible areas. In one aspect, the navigation system 100 may display such information on the map together with the highlighted points of interest (e.g., as a text popup associated with a flag). In another aspect, the navigation system 100 may display a list of such information. The navigation system 100 may display information about identified points of interest located within the accessible areas in other manners as well. In one embodiment, the transit map access function 132 may obtain and display advertisements for the identified points of interest located within the accessible areas or located proximate to those accessible areas. The advertisements may comprise coupons or promotions that encourage the user to visit the point of interest associated with the advertisement. The advertisements may be displayed with the map image or separate from the map image.

A method and system of identifying and displaying areas and/or locations that are accessible from a starting location by public transit under certain conditions is described herein. Although the above method and system have been described using public transit, the same method and system may be applied with time, distance and mobility constraints (trip conditions) for a trip with any mode(s) of transport including or excluding public transit. It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

I claim:

1. A method of operating a navigation system comprising:
receiving into the navigation system a query for one or more areas accessible from a starting location by public transit under one or more trip conditions;
identifying a first transit stop in proximity to the starting location;
identifying at least one travel route along a public transit line that connects to the identified transit stop;
identifying at least one second transit stop on the identified travel route that can be accessible under one or more trip conditions;
identifying regions around the second transit stop that can be accessible from the second transit stop under the one or more trip conditions; and
generating a map that highlights the identified regions around the second transit stop that can be accessible from the second transit stop under the one or more trip conditions.

2. The method of claim 1, wherein the one or more trip conditions comprise one or more of a time of day, a maximum travel time, a maximum travel cost, a preferred type of public transit, a permitted type of public transit, a maximum number of transfers between public transit lines, a maximum walking distance, an indication of whether a return trip is desired, and an indication of whether a taxicab can be considered for certain portions of the trip.

3. The method of claim 1, wherein the starting location comprises a current location of the navigation system.

4. The method of claim 1, wherein the starting location comprises a location input by a user.

5. The method of claim 1, wherein identifying regions around the second transit stop that can be accessible from the second transit stop under the one or more trip conditions comprises:
accessing a geographic database to identify road network elements or pedestrian network elements that connect to the second transit stop.

6. The method of claim 1, wherein the map does not depict regions around the second transit stop that cannot be accessible from the second transit stop under the one or more trip conditions.

7. The method of claim 1, wherein the map that highlights the identified regions around the second transit stop comprises a map that shades the identified regions.

8. The method of claim 1, wherein the query comprises a query for one or more points of interest.

9. The method of claim 1, further comprising:
identifying points of interest located within the identified regions around the second transit stop that can be accessible from the second transit stop under the one or more trip conditions accessible one or more areas.

10. A navigation system comprising:
a user interface configured to receive input and provide output;
a processor;
data storage containing a geographic database having data representing a plurality of public transit lines, public transit stops and road segments in a geographic region; and
program instructions stored in data storage and executable by the processor to:
receive a query for at least one area accessible from a starting location by public transit under a trip condition;
identifying a first transit stop in proximity to the starting location;
identifying at least one public transit line that connects to the identified transit stop;
identifying at least one second transit stop on the identified transit line that is accessible under the trip condition;
identifying at least one road segment that connect to the identified second transit stop;
determining a distance of travel along the identified road segment under the trip condition; and
generating a map that highlights the identified distance identified road segment under the trip condition.

11. The navigation system of claim 10, wherein the trip condition comprises one or more of a time of day, a maximum travel time, a maximum travel cost, a preferred type of public transit, a permitted type of public transit, a maximum number of transfers between public transit lines, a maximum walking distance, an indication of whether a return trip is desired, and an indication of whether a taxicab can be considered for certain portions of the trip.

12. The navigation system of claim 10, further comprising a communication interface configured to communicate with one or more computing devices.

13. The navigation system of claim 10, wherein identifying at least one road segment that connect to the identified second transit stop comprises:
accessing the geographic database for data representing a connection between the road segment and the second transit stop.

14. The navigation system of claim 10, wherein the map does not highlight portions of a road network that cannot be accessible from the second transit stop under the trip condition.

15. A method comprising:
receiving into a computing platform a query for one or more areas accessible from a starting location by public transit under one or more trip conditions;
identifying one or more areas accessible from the starting location by public transit under the one or more trip conditions;
providing a map that highlights the accessible one or more areas and does not highlight areas that are not accessible under the one or more trip conditions

16. The method of claim 15, wherein the one or more trip conditions comprise one or more of a time of day, a maximum travel time, a maximum travel cost, a preferred type of public transit, a permitted type of public transit, a maximum number of transfers between public transit lines, a maximum walking distance, an indication of whether a return trip is desired, and an indication of whether a taxicab can be considered for certain portions of the trip.

17. The method of claim 15, wherein identifying the areas accessible comprises:
accessing a geographic database to identify road network elements or pedestrian network elements that connect to the public transit.

18. The method of claim 15, wherein the map does not depict areas that cannot be accessible under the one or more trip conditions.

19. The method of claim 15, wherein the map that highlights the accessible one or more areas comprises a map that shades the accessible one or more areas and that does not shade the areas not accessible.

20. The method of claim 15, wherein the map that highlights the accessible one or more areas comprises a map that visually depicts the geographic features in the accessible one or more areas in a manner that distinguishes those geographic features in the areas not accessible.
